(19) United States
(12) Patent Application Publication
(10) Pub. No.: US 2017/0275879 A1
(43) Pub. Date: Sep. 28, 2017

(54) PREFABRICATED, ENGINEERED, FLOOR PANEL CONSTRUCTION

(71) Applicant: CORRUVEN CANADA INC., Kedgwick (CA)

(72) Inventors: Alain BÉLANGER, Kedgwick (CA); Daniel BEAUREGARD-LONG, Edmundston (CA); Scott PHILIPPE, St-Joseph (CA); Christian JALBERT, St-Jacques (CA)

(21) Appl. No.: 15/466,474

(22) Filed: Mar. 22, 2017

Related U.S. Application Data
(60) Provisional application No. 62/312,134, filed on Mar. 23, 2016.

(51) Int. Cl. E04C 2/34; E04B 5/02; E04F 13/08; B32B 21/06; B32B 3/18; B32B 7/12; B32B 21/04; E04C 2/24; E04F 15/04

(52) U.S. Cl. CPC E04C 2/3405; E04C 2/246; E04B 5/02; E04F 13/0866; E04F 15/045; B32B 3/18; B32B 7/12; B32B 21/042; B32B 21/06; E04C 2002/3444; B32B 2250/03; B32B 2419/00

(57) ABSTRACT

The prefabricated floor panel can include at least two planar panel members being spaced apart by and sandwiching a core, the core having at least one undulated inner support extending along a longitudinal axis and having summit portions, valley portions, and intermediate portions each extending between corresponding summit and valley portions, each of the summit, valley, and intermediate portions having opposed side edges, a span of the at least one inner support being defined between the opposed side edges, each side edge abutting against a corresponding one of the panel members, the undulated inner support having at least one sheet of wood material, fibres of said sheet of wood material being oriented normal to the panel members and parallel to the span, the at least one undulated inner support being laterally sandwiched between inner ribs with the summits being disposed adjacent a first one of the inner ribs and the valleys being disposed adjacent a second, opposite one of the inner ribs, the inner ribs being planar and having a span being defined between opposed side edges, each side edge of the inner ribs abutting against a corresponding one of the panel members.

### TECHNICAL FIELD

The application relates generally to pre-fabricated building components and, more particularly, to engineered panels.

### SUMMARY

In one aspect, there is provided an engineered panel, comprising: at least two planar panel members being spaced apart by and sandwiching a core, the core having at least one undulated inner support extending along a longitudinal axis and having summit portions, valley portions, and intermediate portions each extending between corresponding summit and valley portions, each of the summit, valley, and intermediate portions having opposed side edges, a span of the at least one inner support being defined between the opposed side edges, each side edge abutting against a corresponding one of the panel members, the undulated inner support having at least one sheet of wood material, fibres of said sheet of wood material being oriented normal to the panel members and parallel to the span, the at least one undulated inner support being laterally sandwiched between inner ribs with the summits being disposed adjacent a first one of the inner ribs and the valleys being disposed adjacent a second, opposite one of the inner ribs, the inner ribs being planar and having a span being defined between opposed side edges, each side edge of the inner ribs abutting against a corresponding one of the panel members.

In another aspect, there is provided a wood floor panel, comprising: a panel body having upper and lower wood panel members being spaced apart from each other to define an inner chamber therebetween; a plurality of elongated inner ribs each disposed within the inner chamber and extending between opposed upper and lower extremities, each of the upper and lower extremities abutting against a corresponding one of the upper and lower panel members, each inner rib being spaced apart from an adjacent inner rib and oriented perpendicularly to the upper and lower panel members; and a plurality of undulated inner supports disposed between within the inner chamber, each inner support extending along a longitudinal axis and having summit portions, valley portions, and intermediate portions each extending between corresponding summit and valley portions, each of the summit, valley, and intermediate portions having opposed upper and lower side edges, a height of each inner support being defined between the opposed side edges, each of the upper and lower side edges abutting against a corresponding one of the upper and lower panel members.

In one aspect, there is provided a wood panel, comprising: at least two planar wood panel members being spaced apart by at least one undulated inner support disposed between the panel members, the at least one inner support extending along a longitudinal axis and having summit portions, valley portions, and intermediate portions each extending between corresponding summit and valley portions, each of the summit, valley, and intermediate portions having opposed side edges, a span of the at least one inner support being defined between the opposed side edges, each side edge abutting against one of the panel members.

### DESCRIPTION OF THE DRAWINGS

Reference is now made to the accompanying figures in which:

FIG. 1 is a perspective view of a section of a wood panel, according to an embodiment of the present disclosure, a portion of an interior of the wood panel being exposed to view; and

FIG. 2 is a top view of the wood panel of FIG. 1.

### DETAILED DESCRIPTION

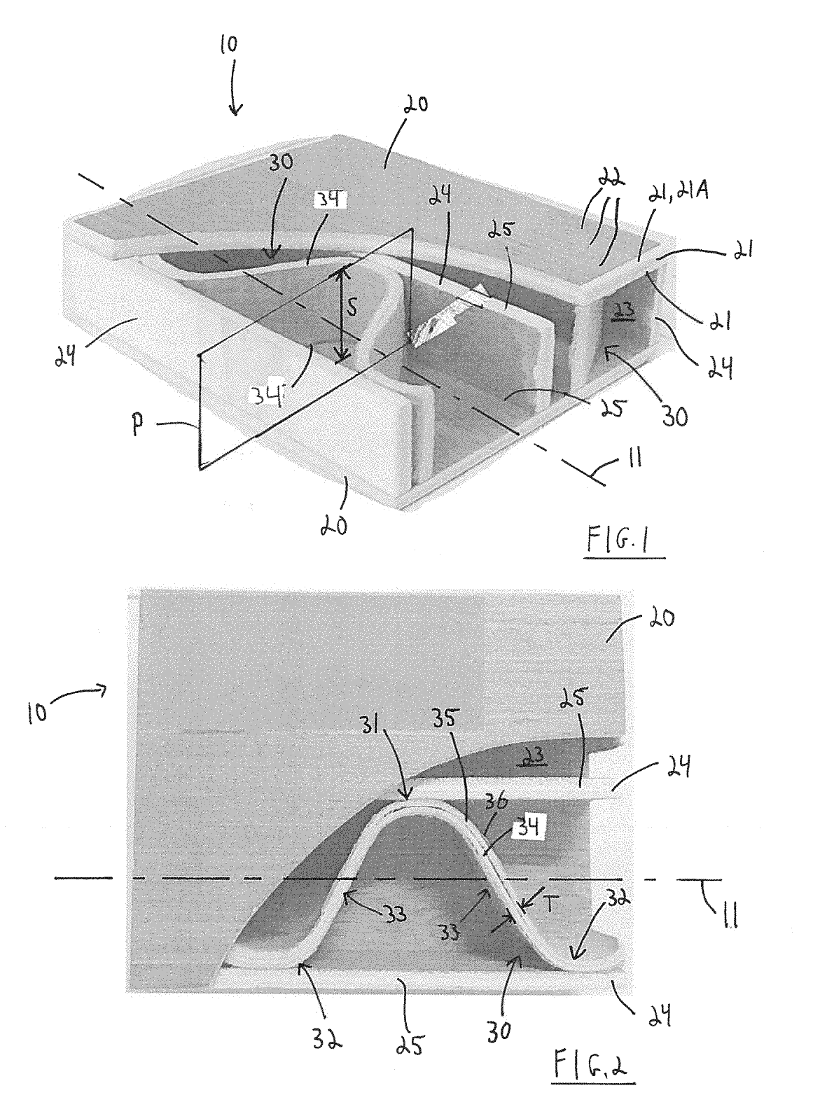

FIGS. 1 and 2 illustrate a section of an engineered panel 10. The panel 10 includes two or more planar panel members 20 which can alternately be referred to as ‘skins’. Each of the panel members 20 provides structure to the panel 10 to allow it to resist the loads applied thereto. In most embodiments, but not necessarily all, the panel members 20 provide the load-bearing surfaces of the panel 10. In the embodiment shown, the panel members 20 are the upper and lower panel members 20 of a floor panel 10. It will be appreciated that other configurations for the panel members 20 are within the scope of the present disclosure. For example, the panel members 20 can be oriented vertically so as to form the inner and outer panel members 20 of a wall panel 10. In another example, the panel members 20 are stacked one atop the other to form a multi-tiered panel 10.

In the embodiment shown, the panel members 20 can be the only portions of the panel 10 that are visible once the panel 10 has been installed. The exposed, outer surfaces of the panel members 20 may therefore have designs, motifs, or be otherwise visually appealing. For example, and as shown in FIGS. 1 and 2, each of the upper and lower panel members 20 can be made of multiple wood plies 21. At least the exposed (i.e. visible) wood ply 21A has a wood grain 22. The orientation of the wood grain 22 can be parallel to a longitudinal axis 11 of the panel 10. In the embodiment shown, the exposed wood ply 21A is an uppermost ply of the upper panel 20, as well as a lowermost ply of the lower panel 20. Each of the panel members 20 has the same wood grain 22 orientation.

The panel members 20 are spaced apart from one another, thereby defining a relatively lightweight hollow panel 10. The space between the panel members 20 is a hollow inner chamber 23 of the panel 10 which receives therein additional structural components of the panel 10 which can collectively be referred to as a core. Each of the structural components provides structural rigidity to the panel 10 so that it can better support loads acting thereon. Some of these structural components are now described in greater detail.

One such structural component is a plurality or inner ribs 24. In the embodiment where the panel is used as a prefabricated floor, the inner ribs 24 can provide a structural function which can be compared to the structural function of joists or I-beams which support the flooring in some constructions. Each inner rib 24 is located within the inner chamber 23, between two panel members 20, and spaced apart from other inner ribs 24. Each inner rib 24 extends along a direction that is parallel to the longitudinal axis 11 in this embodiment, and also extends between two panel members 20. More particularly, opposed extremities 25 of each inner rib 24 abut against an inner surface of both panel members 20. The inner ribs 24 are thus oriented transverse, or perpendicularly (normal) to, the panel members 20. For example, if the panel members 20 have a horizontal orientation, the inner ribs 24 will have a vertical orientation and form a substantially right angle with each of the panel members 20 against which they abut. It can thus be appreciated that each inner rib 24 reinforces the panel members 20 and provides structural support thereto. The inner ribs can be secured to the panel members 20 by an adhesive, fasteners, or in any other suitable manner, for instance. Collectively, the inner ribs 24 can be said to be sandwiched between the panel members 20.

Another structural component of the core is one or more undulated inner supports 30. In this embodiment, the undulations of the inner supports 30 are oriented laterally, and are sandwiched between the inner ribs 24 with the undulations being best seen when taking a cross-sectional view parallel to the panel members 20. Each undulated inner support 30 is located within the inner chamber 23 between the panel members 20, and extend along the longitudinal axis 11 of the panel 10.

The term “undulated” refers to the sinuous or billowing form of each inner support 30 along its length. Although shown in FIGS. 1 and 2 as being substantially sinusoidal or wave-like, the inner support 30 disclosed herein can take other undulated forms as well. For example, one or more of the inner supports 30 can have a substantially planar oscillating form, a triangular form, or any other suitable shape. Irrespective of the form of the undulated inner support 30, it will have summit portions 31, valley portions 32, and intermediate portions 33 that each extend between and connect the summit and valley portions 31,32. The terms “summit” and “valley” are used herein for convenience, and can be reversed. Any other suitable term for referring to the opposed maxima and minima of the inner support 30 can also be used. The summit and valley portions 31,32 of adjacent inner supports 30 can be offset from one another. The term “offset” refers to the undulated inner supports 30 being out of phase, such that the summit and valley portions 31,32 of adjacent inner supports 30 are angularly or longitudinally misaligned.

Each of the inner supports 30 is delimited by side edges 34. Each side edge 34 is located on an opposite side extremity of each inner support 30, and extends along the length of the inner support 30. Each side edge 34 therefore extends along each of the summit, valley, and intermediate portions 31,32,33 of the inner supports 30.

Each side edge 34 engages, by abutting thereagainst, the inner surfaces of one of the panel members 20 along the entire length of the inner support 30. Each side edge 34 therefore provides structural support to the panel members 20 to assist them in resisting loads applied thereon. The surface area of each side edge 34, which can be defined as the thickness T of each inner support 30 multiplied by its length, may therefore be considered a structural support surface against which the panel members 20 can be applied which provides load-bearing support to the panel members 20.

Each of the inner supports 30 has a span S or extent, which is defined between the opposed side edges 34. The span S is used to designate a measurement of the inner support 30, and can designate different dimensions of the inner support 30 depending on the orientation of the panel 10. For example, in the embodiment shown, the panel 10 is a floor panel and the panel members 2 are orientated substantially horizontally. Each inner support 30 is therefore substantially upright, and thus has upper and lower side edges 34 which respectively abut against the upper and lower panel members 20. In such an embodiment, the span S of each inner support 30 designates its height dimension. In this embodiment, the span S of each inner support 30 is measured in a plane P being perpendicular to the longitudinal axis 11.

In the embodiment shown, each inner support 30 is located within the inner chamber 23 between two spaced-apart inner ribs 24. More particularly, the summit portions 31 of each inner support 30 are positioned adjacent to one of the inner ribs 24, and the valley portions 32 are positioned adjacent to the other one of the inner ribs 24. In the embodiment shown, the summit and valley portions 31,32 are attached to their respective inner ribs 24 by a suitable adhesive. In alternate embodiments, the summit and valley portions 31, 32 can be unattached to the inner ribs 24, and rather be used mainly to trap the inner ribs 24 by abutment thereagainst in an upright and parallel configuration during production and subsequent structural use. The inner supports 30 can complement the structural support provided by the inner ribs 24. It will be appreciated that the inner supports 30 can be used independently of the inner ribs 24, such that only inner supports 30 are present within the inner chamber 23 to provide structural support to the panel 10.

The inner ribs and panel members can be made of any suitable material, or combination of materials which can include hard woods, soft woods, plastic, metal, or combinations of these materials. The wood layers used can be of more than one ply.

The inner supports 30 can be made from any suitable material. In the embodiment shown, one or more of the inner supports 30 are made, at least partially, from a wood material. More particularly, one or more of the inner supports 30 is made from at least one wood sheet 35, and at least one paper support sheet 36 adhered to the at least one wood sheet. The one or more paper support sheets 36 can be a flexible support sheet that is adhered to the wood sheet 35 by an adhesive. The paper support sheet 36 can be a Kraft paper, or any alternate suitable flexible layer, such as a film, a foil, a fabric, a mesh, for example. By flexible, what is to be understood is that the paper support sheet 36 has a flexibility which is greater than that of the wood sheet 35. In this example, the undulated inner supports 30 are provided in the form of wood composite components and can have at least one wood ply, resin or adhesive, and optionally also have one or more paper ply. The undulated inner support 30 can be manufactured based on the teachings of PCT publication WO 2010/060219, by applicant.

In light of the preceding, it can be appreciated that the undulated configuration of each inner support 30 can provide a means to support the inner ribs in their normal orientation relative to the panel members, and can additionally be used to provide additional structural support while minimising the weight of the panel 10. The one or more inner supports 30 can therefore contribute to making the panel 10 a light-weight structural panel. For example, the undulated side edges 34 engage the panel members 20 along the entire length of the inner supports 30 and thus provide support to the panel members 20 along all of the above-described structural support surface. In addition, in the embodiment where the surfaces of the summit and valley portions 31,32 engage the inner ribs 24, the inner supports 30 assist the inner ribs 24 to resist collapsing inwardly under the loads applied to the panel members 20. The configuration of each inner support 30 compares favourably to some conventional panels which have only spaced-apart inner ribs 24 because the structural support surface provided by each inner support 30 is greater than that provided by the opposed extremities 25 of each inner rib 24. A panel 10 relying only on such inner ribs 24 for structural support would therefore require more internal structural components, and thus have a greater weight, than a panel 10 using the disclosed inner supports 30.

The engineered panel 10 shown can be used as a structural body for any suitable application such as a floor panel, a sub-floor panel, a wall panel, a decorative panel, etc. The term “structural” refers to the fact that the engineered panel 10 (or simply “panel 10”) can be load-bearing. While shown and described herein as being a structural panel 10, the panel 10 can in addition be used for aesthetic or decorative purposes.

In various embodiments, the distance between the inner ribs or joists, and their structural characteristics (material, width, etc.), can be specifically engineered as a function of the intended use of the engineered panel.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. An engineered panel, comprising: at least two planar panel members being spaced apart by and sandwiching a core, the core having at least one undulated inner support extending along a longitudinal axis and having summit portions, valley portions, and intermediate portions each extending between corresponding summit and valley portions, each of the summit, valley, and intermediate portions having opposed side edges, a span of the at least one inner support being defined between the opposed side edges, each side edge abutting against a corresponding one of the panel members, the undulated inner support having at least one sheet of wood material, fibres of said sheet of wood material being oriented normal to the panel members and parallel to the span, the at least one undulated inner support being laterally sandwiched between inner ribs with the summits being disposed adjacent a first one of the inner ribs and the valleys being disposed adjacent a second, opposite one of the inner ribs, the inner ribs being planar and having a span being defined between opposed side edges, each side edge of the inner ribs abutting against a corresponding one of the panel members.

2. The engineered panel of claim 2, wherein the summit and valley portions are attached to their respective inner ribs with an adhesive.

3. The engineered panel of claim 1, wherein each of the panel members is made of multiple wood plies, at least an exposed one of the wood plies having a wood grain with a wood grain orientation being parallel to the longitudinal axis.

4. The engineered panel of claim 1, wherein the at least one inner support is made from at least one wood sheet and at least one paper support sheet adhered to the at least one wood sheet.

5. The engineered panel of claim 1 wherein the engineered panel is provided in the form of a prefabricated floor product.

6. A prefabricated floor panel, comprising:
a panel body having upper and lower wood panel members being spaced apart from each other to define an inner chamber therebetween;
a plurality of elongated inner ribs each disposed within the inner chamber and extending between opposed upper and lower extremities, each of the upper and lower extremities abutting against a corresponding one of the upper and lower panel members, each inner rib being spaced apart from an adjacent inner rib and oriented perpendicularly to the upper and lower panel members; and
a plurality of undulated inner supports disposed between within the inner chamber, each inner support extending along a longitudinal axis and having summit portions, valley portions, and intermediate portions each extending between corresponding summit and valley portions, each of the summit, valley, and intermediate portions having opposed upper and lower side edges, a height of each inner support being defined between the opposed side edges, each of the upper and lower side edges abutting against a corresponding one of the upper and lower panel members.

7. The wood floor panel of claim 6, wherein the height of the at least one inner support is defined in a plane being perpendicular to the longitudinal axis.

8. The wood floor panel of claim 6, wherein each inner support is disposed between two spaced-apart inner ribs, the summit portions of said inner support being attached to one of the inner ribs, and the valley portions being attached to the other one of the inner ribs.

9. The wood floor panel of claim 8, wherein the summit and valley portions are attached to their respective inner ribs with an adhesive.

10. The wood floor panel of claim 6, wherein the inner ribs extend along a direction being parallel to the longitudinal axis.

11. The wood floor panel of claim 6, wherein each of the upper and lower panel members is made of multiple wood plies, at least an exposed one of the wood plies having a wood grain with a wood grain orientation being parallel to the longitudinal axis.

12. The wood floor panel of claim 15, wherein said exposed wood ply is an uppermost ply of the upper wood panel, and a lowermost ply of the lower wood panel.

13. The wood floor panel of claim 6, wherein at least one of the inner supports is made at least partially from a wood material.

14. The wood floor panel of claim 6, wherein at least one of the inner supports is made from at least one wood sheet and at least one paper support sheet adhered to a side of the at least one wood sheet.

15. The wood floor panel of claim 6, wherein the summit and valley portions of adjacent inner supports are offset from each other.

16. A wood panel, comprising: at least two planar wood panel members being spaced apart by at least one undulated inner support disposed between the panel members, the at least one inner support extending along a longitudinal axis and having summit portions, valley portions, and intermediate portions each extending between corresponding summit and valley portions, each of the summit, valley, and intermediate portions having opposed side edges, a span of the at least one inner support being defined between the opposed side edges, each side edge abutting against one of the panel members.
